(19) United States
(12) Patent Application Publication
(10) Pub. No.: US 2003/0182200 A1
(43) Pub. Date: Sep. 25, 2003

(54) Commercial transaction system and method using quantity-based units costs

(76) Inventor: Ung-Ryul Lee, Seoul (KR)

Correspondence Address: CHRISTIE, PARKER & HALE, LLP, 350 WEST COLORADO BOULEVARD, SUITE 500, PASADENA, CA, 91105, US

(21) Appl. No.: 10/240,146

(22) PCT Filed: Mar. 28, 2001
(86) PCT No.: PCT/KR01/00505

(30) Foreign Application Priority Data
Mar. 28, 2000 (KR) 2000-0015848

(51) Int. Cl. G06F 17/60

(52) U.S. Cl. 705/26

(57) ABSTRACT

Disclosed is a commercial transaction system and method that uses differential unit costs based on the quantity of each shopping item selected by a purchaser who is connected to a web site for electronic commercial transaction services, to fix the shopping cost of the corresponding item. The commercial transaction system using quantity-based differential unit costs, which allows a purchaser to execute a commercial transaction when the purchaser is connected to a network via a client computer, includes: a shopping mall providing server for providing a virtual shopping mall that enables the purchaser to execute a commercial transaction; and a purchase terms decision agent for receiving shopping information including the quantity of a shopping item entered by the purchaser through the client computer, and fixing the quantity-based unit cost of the shopping item and the available period of the unit cost. This commercial transaction system benefits a purchaser who buys a large quantity of the corresponding item.

### BACKGROUND OF THE INVENTION

(a) Field of the Invention

The present invention relates to a commercial transaction system and method using quantity-based unit costs. More specifically, the present invention relates to a commercial transaction system and method that uses differential unit costs based on the quantity of each shopping item selected by the purchaser, who is connected to a web site for electronic commercial transaction services, to fix the shopping cost of the corresponding item.

(b) Description of the Related Art

With the explosive growth in electronic commercial transaction services, a variety of items are being marketed and purchased on the Internet network. Correspondingly, more and more shopping mall web sites are created as virtual spaces for marketing and purchasing such goods on the Internet. These shopping mall web sites are designed to fix the shopping cost of each item irrespective of the purchase quantity of the item by one purchaser, so that the purchaser cannot benefit in the shopping cost based on the purchase quantity. In addition, such on-line commercial transactions may be unprofitable to a purchaser who buys a large quantity of goods in the transactions between companies or between company and government.

### SUMMARY OF THE INVENTION

It is an object of the present invention to solve the problem and to provide a commercial transaction system and method using differential unit costs based on the quantity of each shopping item, thereby benefiting a purchaser who buys a large quantity of the corresponding item.

In one aspect of the present invention, there is provided a commercial transaction system using quantity-based differential unit costs, which system includes client computers that drive a web browser, a shopping mall providing server, and an Internet service providing host that connects the client computers to the shopping mall providing server on the network. The shopping mall providing server presents information about sell items and item-based unit costs to the purchaser, and includes a shopping mall management unit receiving information about the item selection and quantity, a product database storing data about the sell items, and a shopping mall database.

The product database includes an item-based unit cost database, and a unit cost-based available period database.

The shopping mall providing server includes a purchase terms decision agent that receives the unit costs of shopping items from a database, presents the item-based unit costs to the purchaser through a shopping mall management unit, and uses available period data received from the database to ascertain whether the unit cost of each shopping item received from the database is valid.

In another aspect of the present invention, there is provided a commercial transaction method using quantity-based differential unit costs, which is applied to a commercial transaction system using quantity-based differential unit costs including a virtual shopping mall that allows a purchaser to execute a commercial transaction when the purchaser is connected to a network. The commercial transaction method includes: (a) the virtual shopping mall receiving information about shopping items and the quantity of each shopping item as entered by a purchaser through a client computer; (b) the virtual shopping mall deciding the shopping cost of each shopping item based on the shopping item and the quantity entered by the purchaser, and the available period of the shopping cost; and (c) sending information about the shopping cost and the available period of the shopping cost to the purchaser.

In the commercial transaction method, (a) further includes: (d) presenting shopping items available; and (e) causing the purchaser to select his/her desired items of the shopping items presented.

### BRIEF DESCRIPTION OF THE DRAWINGS

The accompanying drawings, which are incorporated in and constitute a part of the specification, illustrate an embodiment of the invention, and together with the description, serve to explain the principles of the invention:

FIG. 1 is an entire schematic view of a commercial transaction system using quantity-based differential unit costs according to the present invention;

FIG. 2 is an illustration of an example of a database according to the present invention; and

FIG. 3 is a flow chart of a commercial transaction system using quantity-based differential unit costs according to the present invention.

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

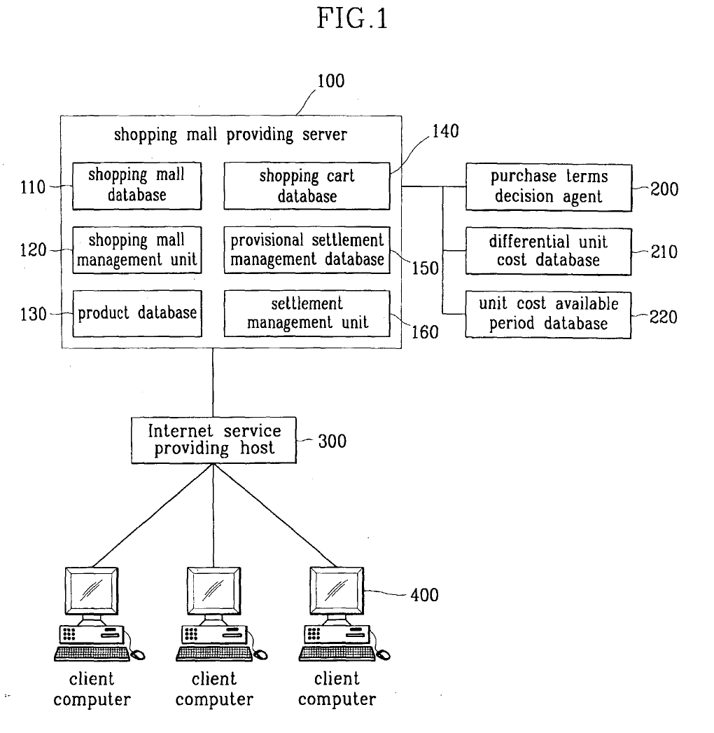

FIG. 1 is an entire schematic view of a commercial transaction system using quantity-based differential unit costs according to an embodiment of the present invention.

As shown in FIG. 1, the commercial transaction system using quantity-based differential unit costs according to the embodiment of the present invention includes a shopping mall providing server 100, a purchase terms decision agent 200, an Internet service providing host 300, and a plurality of client computers 400.

The shopping mall providing server 100, the purchase terms decision agent 200 and the client computers 400 are interconnected to establish a communication path over the network via the Internet service providing host 300. The shopping mall providing server 100 includes a shopping mall database 110, a shopping mall management unit 120, a product database 130, and a settlement management unit 140. The shopping mall providing server 100 may further include a provisional settlement management database 150, and a shopping cart database 160.

The shopping mall database 110 stores various data necessary to constitute a shopping mall.

The shopping mall management unit 120 presents information about shopping items and quantity-based unit costs of each shopping item to the purchaser, and receives order information including shopping items and quantity of each shopping item selected from the purchaser. That is, the shopping mall management unit 120 presents, as needed, information about shopping items, quantity-based unit cost of each shopping item, minimum quantity unit of each item, item-based shopping cost fixed in consideration of the quantity and unit cost of the corresponding shopping item, items in the shopping cart, order confirmation, etc. The shopping mall management unit 120 also receives, from the purchaser, order information including selected shopping items, item-based quantity, whether to put an ordered item in the shopping cart, whether to place an additional order, order confirmation, etc.

The product database 130 stores data about sell items and quantity unit of each sell item.

The settlement management unit 140 manages settlement of accounts for the shopping items that the purchaser orders in the virtual shopping mall.

The provisional settlement management database 150 stores data received from the purchaser, including ordered shopping items, item-based quantity, quantity-based unit cost of each item, and shopping cost of the corresponding items.

The shopping cart database 160 stores data of the ordered shopping items in the same format as the provisional settlement management database 150 and additionally data about the total shopping cost, i.e., the sum of shopping costs of the individual items.

The purchase terms decision agent 200 receives data about quantity-based differential unit costs of each shopping item entered by the purchaser from a differential unit cost database 210, and determines from the received data whether the unit cost is valid, i.e., whether it falls between validity start and end dates received from a unit cost available period database 220. If the unit cost is valid, the purchase terms decision agent 200 presents the available period of the unit cost to the purchaser through the shopping mall management unit 120; otherwise, it updates the unit cost available period database 220.

The differential unit cost database 210 stores data about shopping items and quantity-based differential unit costs.

The unit cost available period database 220 stores data about the available periods for quantity-based unit costs of items. The quantity-based unit cost of each item is associated with the data about validity start and end dates and has to fall between validity start and end dates in order to be presented to the purchaser.

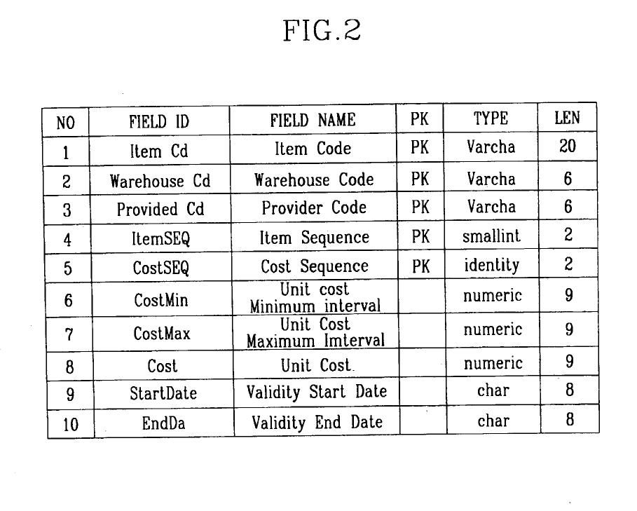

FIG. 2 is an illustration of an example of the database 120 according to the present invention.

Reference numerals 1 to 4 denote product details automatically associated with product selection. Reference numeral 5 denotes a unit cost sequence that indicates the number of intervals between maximum and minimum unit costs. Reference numerals 6, 7 and 8 represent the minimum unit cost, the maximum unit cost and the quantity-based unit cost, respectively. Reference numerals 9 and 10 are devices for displaying the unit cost updated in such a manner that the previous unit cost is applied to the validity end date and the current unit cost is applied to the validity start date.

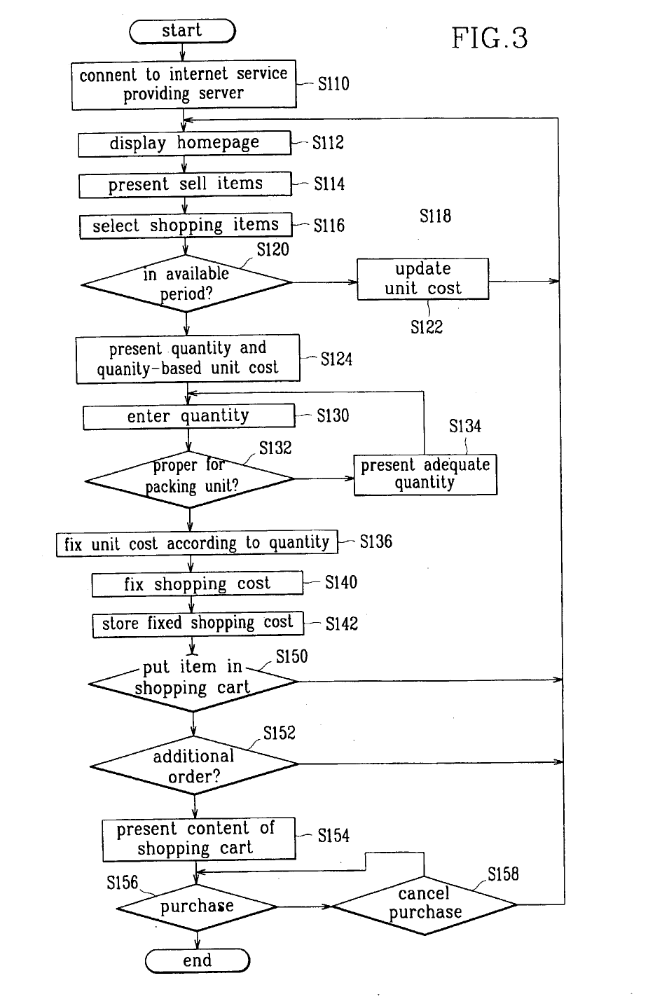

FIG. 3 is a flow chart of a commercial transaction system using quantity-based differential unit costs according to an embodiment of the present invention.

Referring to FIG. 3, a purchaser drives a web browser of the subscriber server and connects to the shopping mall providing server 100 via an Internet service providing host, in step 110.

Then, a home page supplied from the shopping mall providing server 100 is displayed on the web browser of the purchaser, in step 112. The shopping mall providing server 100 presents information about shopping items available in the home page via the shopping mall management unit 120, in step 114. The purchaser selectively enters his/her desired shopping items, in step 116.

The purchase terms decision agent 200 receives quantity-based unit costs of the selected shopping items from the database 210 and ascertains whether the unit cost of each shopping item is valid, i.e., whether it falls in a period between validity start and end dates, in step 120. If the unit cost of a shopping item is invalid, the purchase terms decision agent 200 updates the cost, in step 122. Otherwise, if the unit cost of the shopping item is valid, the purchase terms decision agent 200 presents the quantity-based unit cost of the shopping item together with the quantity of the item to the purchaser through the shopping mall management unit 120, in step 124.

The purchaser enters the quantity of each shopping item in consideration of the quantity-based unit cost, in step 130. The purchase terms decision agent 200 ascertains in step 132 whether the quantity of each shopping item entered is proper to a defined packing unit. If the quantity entered is improper for the packing unit, the purchase terms decision agent 200 presents adequate quantity for the packing unit to the purchaser, in step 134. Otherwise; if the quantity entered is proper for the packing unit, the purchase terms decision agent 200 fixes the shopping cost in consideration of the quantity of the shopping item and the quantity-based unit cost and presents the fixed shopping cost to the purchaser. Through these procedures, the purchase terms decision agent 200 stores necessary data, i.e., shopping items, item-based quantity, quantity-based unit cost and shopping cost in the provisional settlement management database 150, in steps 140 and 142.

The purchaser is queried whether to store the corresponding shopping item in the shopping cart. If the purchaser makes an affirmative answer, then the data value of the provisional settlement management database is sent to the shopping cart database 160 and the total shopping cost indicating the sum of the item-based shopping costs is stored in the shopping cart database 160, in step 150. If the purchaser makes a negative answer, the data of the provisional settlement management database is deleted and the home page is displayed on the web browser through the shopping mall management unit 120. The purchaser is also queried whether to place an additional order. When the purchaser answers yes, shopping items available are presented again in step 152; otherwise, when the purchaser answers no, the content of the shopping cart is displayed to the purchaser in step 154. The purchaser is then queried whether to make an order for the shopping item. If the purchaser makes a negative answer, the data of the shopping cart database 160 is deleted; otherwise, if the purchaser makes an affirmative answer, an order for the shopping item is made, in step 156.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

The transaction system and method according to the present invention have the following effects.

First, the purchaser gains an opportunity to purchase items at a low price when he/she purchases a large quantity of items through electronic commercial transactions over the Internet network.

Second, the above effect enables electronic commercial transactions between companies and between a company and government.

Finally, provisions of quantity-based discount cost information and consistent prices in the electronic commercial transactions may secure fair transactions between companies and between a company and government.

What is claimed is:

1. A commercial transaction system using quantity-based differential unit costs, which allows a purchaser to execute a commercial transaction when the purchaser is connected to a network via a client computer, the commercial transaction system comprising:
a shopping mall providing server for providing a virtual shopping mall that enables the purchaser to execute a commercial transaction; and
a purchase terms decision agent for receiving shopping information including quantity of a shopping item entered by the purchaser through the client computer, and fixing a quantity-based unit cost of the shopping item and an available period of the unit cost.

2. The commercial transaction system as claimed in claim 1, wherein the shopping mall providing server comprises:
a shopping mall database for storing data about the virtual shopping mall;
a product database for storing information about items provided in the virtual shopping mall;
a shopping mall management unit for providing information about shopping items necessary to the purchaser via the virtual shopping mall; and
a settlement management unit for managing settlement of accounts for a shopping item that the purchaser decides to buy in the virtual shopping mall.

3. The commercial transaction system as claimed in: claim 1, further comprising a differential unit cost database for storing data about the unit costs of shopping items and the available periods of the unit costs.

4. The commercial transaction system as claimed in claim 3, wherein the differential unit cost database includes a product database, an item-based packing unit database, and a packing unit-based unit cost database.

5. The commercial transaction system as claimed in claim 1, wherein the shopping mall providing server further comprises:
a provisional settlement management database for storing data about shopping items, item-based quantity, item-based unit cost, and item-based shopping cost as entered by the purchaser; and
a shopping cart database for storing data about shopping items, item-based quantity, item-based unit cost, item-based shopping cost, and total shopping cost as entered by the purchaser.

6. The commercial transaction system as claimed in claim 5, wherein the purchase terms decision agent receives the unit costs of shopping items from a database, and presents the item-based unit costs to the purchaser through a shopping mall management unit.

7. The commercial transaction system as claimed in claim 6, wherein the purchase terms decision agent uses available period data received from the database to ascertain whether the unit cost of each shopping item received from the database is valid.

8. The commercial transaction system as claimed in claim 6, wherein the purchase terms decision agent updates the data about the unit cost of each shopping item stored in the database unless the item-based unit cost received from the database falls in the available period.

9. A commercial transaction method using quantity-based differential unit costs, which is applied to a commercial transaction system using quantity-based differential unit costs including a virtual shopping mall that allows a purchaser to execute a commercial transaction when the purchaser is connected to a network, the commercial transaction method comprising:
(a) the virtual shopping mall receiving information about shopping items and quantity of each shopping item as entered by the purchaser through a client computer; and
(b) the virtual shopping mall deciding a shopping cost of each shopping item based on the shopping item and the quantity, entered by the purchaser, and an available period of the shopping cost.

10. The commercial transaction method as claimed in claim 9, further comprising (c) sending information about the shopping cost and the available period of the shopping cost to the purchaser.

11. The commercial transaction method as claimed in claim 9, wherein (a) further comprises:
(d) presenting shopping items available; and
(e) causing the purchaser to select his/her desired items of the shopping items presented.

12. The commercial transaction method as claimed in claim 10, wherein (c) further comprises:
(f) presenting quantity-based unit costs of the shopping items selected by the purchaser of the shopping mall;
(g) causing the purchaser of the shopping mall to select the quantity of each shopping item; and
(h) presenting item-based shopping costs based on the shopping items and the quantity of each shopping item as selected by the purchaser of the shopping mall.

13. The commercial transaction method as claimed in claim 12, wherein (f) further comprises:
(i) receiving the quantity-based unit costs of the shopping items from a database;
(j) ascertaining whether the quantity-based unit cost of each shopping item is valid; and
(k) presenting the purchaser with the quantity-based unit costs of the shopping items that are validated.

14. The commercial transaction method as claimed in claim 12, wherein (g) further comprises:
(l) ascertaining whether the quantity of each shopping item selected by the purchaser is proper for a packing unit.

15. The commercial transaction method as claimed in claim 14, wherein (l) further comprises:
(m) presenting an adequate quantity of each shopping item when the quantity selected by the purchaser is improper for the packing unit.
